(19) United States
(12) Patent Application Publication
(10) Pub. No.: US 2006/0245719 A1
(43) Pub. Date: Nov. 2, 2006

(54) Digital airborne video cassette recorder and player

(76) Inventor: William H. Carroll, Ridgecrest, CA (US)

Correspondence Address: NAVAIRWD COUNSEL GROUP, 575 "I" AVE, SUITE 1 (CODE K00000E), BUILDING 36, ROOM 2308, POINT MUGU, CA, 93042-5049, US

(21) Appl. No.: 11/124,643

(22) Filed: May 2, 2005

(51) Int. Cl. H04N 5/91

(52) U.S. Cl. 386/46

(57) ABSTRACT

A digital video cassette recorder which is adapted for use on an aircraft to record video data in a digital format as opposed to an analog format. The recorder includes a frame sync card for adding color burst to video which is black and white and a GPS to SMPTE converter which passes the video signal through converter to the video cassette recorder and also uses the video signal to encode Time, Space, and Position Information data onto a SMPTE time code for each frame of video data supplied to the recorder.

### BACKGROUND OF THE INVENTION

1. Field of the Invention

The present invention relates generally to video recording equipment with playback capability. More specifically, the present invention relates to a digital format video cassette recorder with playback capabilities and a recording format which is compatible with electronic systems on board and aircraft.

2. Description of the Prior Art

Airborne video cassette recorders in use by the military are generally analog units which is a dated technology. Analog data may be lost and copied analog data is not as reliable as the data recorded on a cassette from which the copy is made.

Currently, the only digital format video cassette recorders in use are specialty recorders such as DCT (Discrete Cosine Transform) format recorders used in the Advanced Tactical Reconnaissance Airborne System. This type of digital video cassette recorder is very expensive, is not sized to fit in an aircraft cockpit and not easily adapted for use with the aircraft electronics and sensor systems such as an aircraft's FLIR (forward looking infrared) devices.

Additional problems associated with video cassette recorders currently in use on military aircraft include lack of time code capability, lack of machine control for multi-tape review, and image quality is often sub-standard.

Further, the quality of video cassette recordings is between 3 MHz and 4 MHz and is analog which overtime will degrade significantly when copied or archived. There is also an effort by the video recording industry to convert from an analog format to a digital format for recording video data and is expected that analog technology will be obsolete within the next three to five years.

Accordingly, there is a need for a digital video cassette recorder which is compact, lightweight, easily adapted for aircraft cockpit use and is fully compatable with the electronics on board the aircraft.

### SUMMARY OF THE INVENTION

The present invention comprises a relatively simple in design, yet highly effective, compact, lightweight and low cost digital video cassette recorder for use in an aircraft to record aircraft flight and other data. The present invention is adapted for use on an aircraft to record video data in a digital format as opposed to an analog format.

Data to be recorded is provided by video sources on board the aircraft including the aircraft's FLIR system and other video sensors on board the aircraft. A frame sync card stabilizes the video signal and adds color burst to the video signal when the aircraft's FLIR system generates a video signal which is black and white. The video signal from frame sync card is supplied to a GPS to SMPTE converter which passes the video signal through the converter and also uses the video signal to encode time and date and TSPI (Time, and Space, Position Information) data onto a SMPTE (Society of Motion Picture and Television Engineers) time code for each frame of video data. The video signal and the SMPTE time code are then supplied to a digital video cassette recorder which records the data in an 8-bit digital format. When a digital format is used to record the video information, the video data will not degrade overtime when the data is backup data or when the data is archived.

### BRIEF DESCRIPTION OF THE DRAWINGS

FIG. 1 is a block diagram of the electronic components for the digital airborne video cassette recorder and player comprising the present invention;

FIG. 2 illustrates a flow diagram for TSPI (Time-Space-Position-Information) data utilizing the digital airborne video cassette recorder and player of FIG. 1;

FIG. 3 is a front view illustrating the control/front panel for the digital video cassette recorder of FIG. 1; and

FIG. 4 is a rear view illustrating the connector panel for the digital video cassette recorder of FIG. 1;

FIG. 5 is a top view of the digital video cassette recorder of FIG. 1 without a protective cover;

FIG. 6 is a side view of the digital video cassette recorder of FIG. 1 without the protective cover;

FIG. 7 is a front view illustrating the protective face cover for the control/front panel of the digital video cassette recorder of FIG. 1; and

FIG. 8 is a right side view illustrating the protective face cover for the control/front panel of the digital video cassette recorder of FIG. 1.

### DETAILED DESCRIPTION OF THE PREFERRED EMBODIMENT

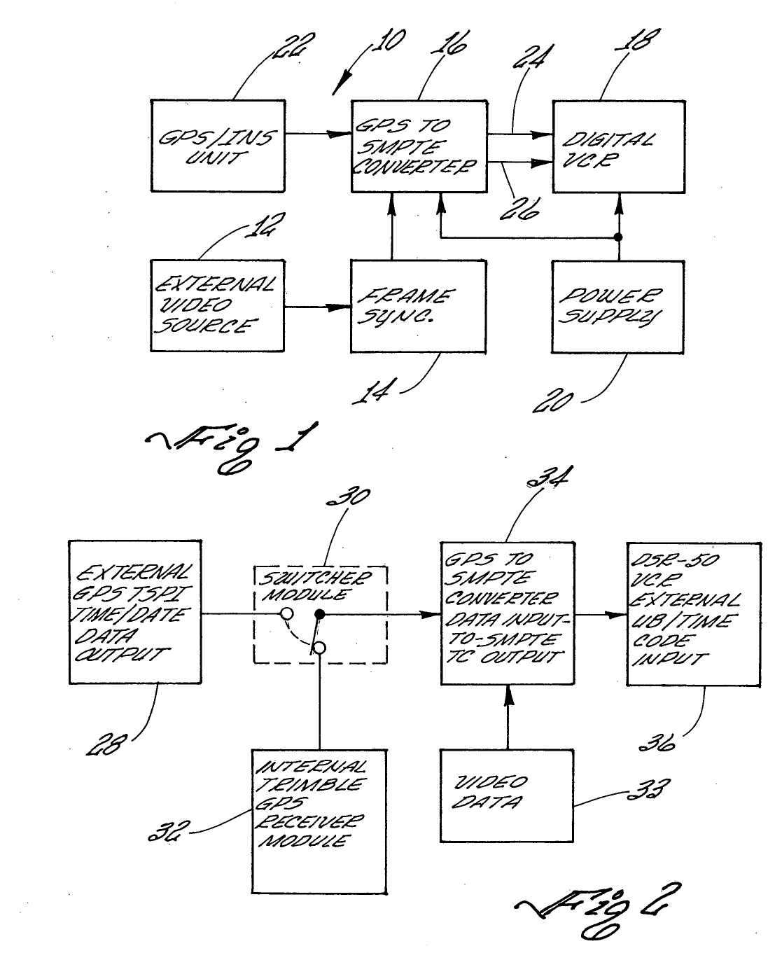

Referring first to FIG. 1, there is a block diagram illustrating a digital airborne video cassette recorder and player 10 which receives data from an external video source 12 located on board a military aircraft. The external video source 12 includes an aircraft's FLIR (forward looking infrared) system and various other digital video data generating devices on board the aircraft. The external video source 12 is connected to a modular video frame sync device/card 14. The output of frame sync device/card 14 is connected to a GPS to SMPTE converter 16 which has its output connected to a digital video cassette recorder 18. Power for digital video cassette recorder 18, GPS to SMPTE converter 16 and frame sync device/card 14 is supplied by a power supply 20 located on board the aircraft.

The frame sync device/card 14 receives a video signal from external video source 12, which processes the signal and adjust the timing of all incoming video signals to the NTSC (National Television System Committee) RS-170 color video standard format. The frame sync card 12 stabilizes the video signal and adds color burst to the video signal when necessary. For example, the aircraft's FLIR system generates a video signal which is black and white, which requires processing of the signal by the frame sync card 12 before supplying the signal to converter 16. This is necessary because the SMPTE (Society of Motion Picture and Television Engineers) time code does not operate correctly (timing is not correct for the SMPTE time code) when a video signal does not have a color burst in the signal.

At this time it should be noted that SMPTE time code is a digital signal whose ones and zeros assign a number to every frame of video representing hours minutes, seconds, frames and additional user specified information such as tape number. For example a time code number 01:12:59:16 represents a picture 1 hour, 12 minutes, 59 seconds and 16 frames into the tape.

The video signal from frame sync card 14 is supplied to GPS to SMPTE converter 16 which passes the video signal through converter 16 and also uses the video signal to time encode time and date data and TSPI (Time, and Space, Position Information) data onto a SMPTE time code for each frame of video data. Converter 16 also assigns a number and data bit to each frame of video data received by converter 16.

Converter 16 receives TSPI data from an external GPS or INS (Inertial Navigation System) unit 22. For example unit 22 may be a commercially available, high accuracy GPS Time and Space Position Information System of the type manufactured by NAVSYS Corporation of Colorado Springs, Colo. has which is designed for military and civilian aircraft use and provides reliable TSPI data.

There are a pair of signal lines/cables 24 and 26 which connect the GPS to SMPTE converter to Digital VCR 18. Signal line 24 sends the video signal to a composite video input for Digital VCR 18. Signal line 26 sends the SMPTE time code with the user bit data for each frame data to the TC/UB (User Bit) input for Digital VCR 18. The actual time may be written into the user bit area.

The power supply 20 connected to digital VCR 18 is a MIL-SPEC-704D 28 to 12 volt step down power supply module which supplies power to the Digital VCR 18 and its internal components. The power supply 20 also has an additional 12 volt output for a GPS receiver.

The digital video cassette recorder used in the preferred embodiment is a Sony model DSR-50 digital cassette recorder which employs a DVCAM tape format which is a digital format. The Sony DVCAM format uses an 8-bit digital component recording format with a 5:1 compression ratio and a sampling rate of 4:1:1 for the NTSC (National Television System Committee) standard. The recorder is capable of recording and playing back DV format tapes. The recorder is also capable of reproducing video at a 6.3 MHz bandwidth which allows for reproduction of video at up to 550 lines of horizontal resolution. The DVCAM format allows for recording of up to 184 minutes with a standard size tape cassette and a 40 minute recording time with a mini-size tape cassette. Other features of the Sony DSR-50 digital cassette recorder include four 32 KHz/12 bit audio tracks which allow a user to record various types of audio including radio, sonar, etc. along with 12 bit audio data. When a digital format is used to record the video information, the video data will not degrade overtime when the data is backup data or when the data is archived.

Referring to FIG. 3, the control/front panel 42 of the Sony digital VCR recorder 18 includes a built-in 2.5 inch color LCD (Liquid Crystal Display) 44 which allows the aircraft's ground crew to check tapes without the need for an external monitor.

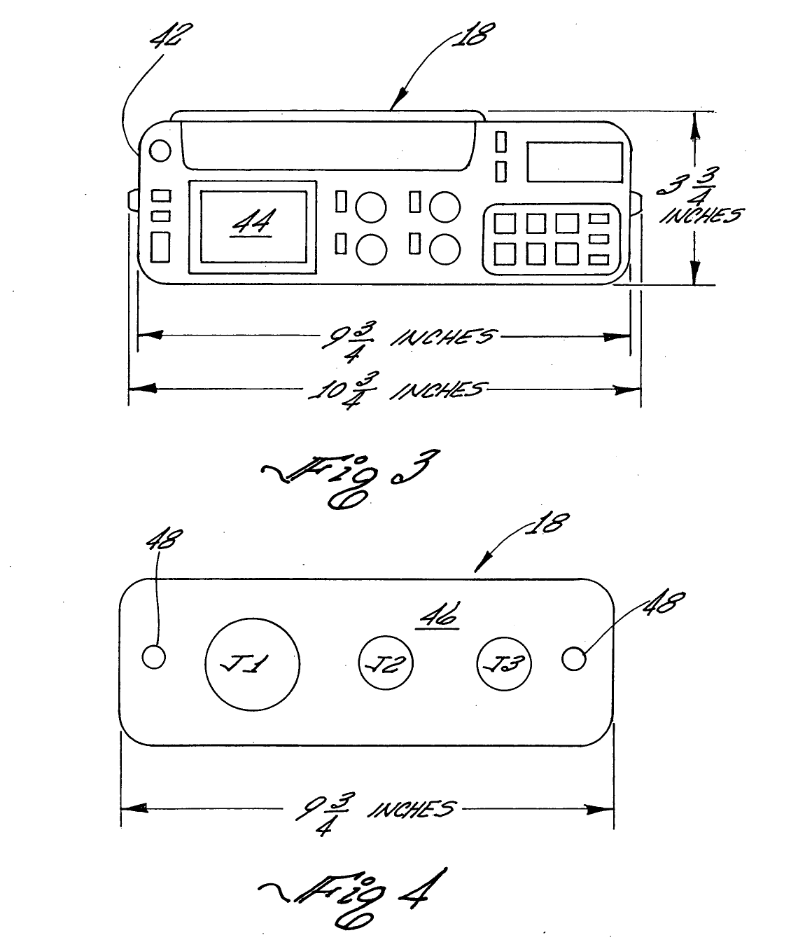

Referring to FIGS. 1 and 2, FIG. 2 illustrates a flow diagram for TSPI (Time-Space-Position-Information) data utilizing the digital video cassette recorder 18 of FIG. 1. Flow diagram block 28 shows that GPS TSPI data is provided by an external GPS/INS unit 22. The GPS TSPI data passes then through a two position switch module 30 to converter 16. The switch module 30 allows a user of digital airborne video cassette recorder and player 10 to select a source for the GPS TSPI data. The source may be an external source or an internal source such as a Trimble GPS Module SVeeSix-CM3 receiver module manufactured by Trimble Inc. of Sunnyvale, Calif. (as depicted by block 32 of the signal flow diagram). The GPS TSPI data is then supplied to converter 16 along with video data (as depicted by block 33 of the signal flow diagram). The GPS TSPI data format from external video source 28 may be provided in the NMEA (National Marine Electronics Association) ACSII format. Digital VCR 18 also accepts data in the TSPI serial binary format.

Converter 16 provides SMPTE Time code (block 34 of FIG. 2) which allows for each frame of video data to be numbered on a dedicated time code track on the digital tape cassette (block 36 of FIG. 2). The time code provided by converter 16 allows multiple tapes from a single aircraft to be accurately synchronized and also allows for tapes from multiple aircraft to be synchronized. Currently, analog video recorders on aircraft do not have SMPTE type time coding which means that video recordings can not be synchronized with any degree of accuracy during playback which substantially distorts the accuracy of events recorded on the tapes during playback review of the tapes.

Recording GPS TSPI data on digital tape cassettes allows military and civilian aircraft pilots to review position information during playback. The GPS to SMPTE converter 16 translates NMEA ASCII Serial GPS data into user bit data that is inserted into the SMPTE time code on the digital video tape.

Sony's DVCAM format is an in expensive format (under $10,000) which allows for a continuous upgrade of information recorded in the user bit portion of the SMPTE time code. User bit playback capability offers several advantages including the display of GPS TSPI data at various speeds of playback and display of the TSPI data during a still frame. The DVCAM format also allows digital cassette tapes to be labeled with information such as the pilot's name and aircraft number on a data code track that be displayed at a later date on a playback VCR.

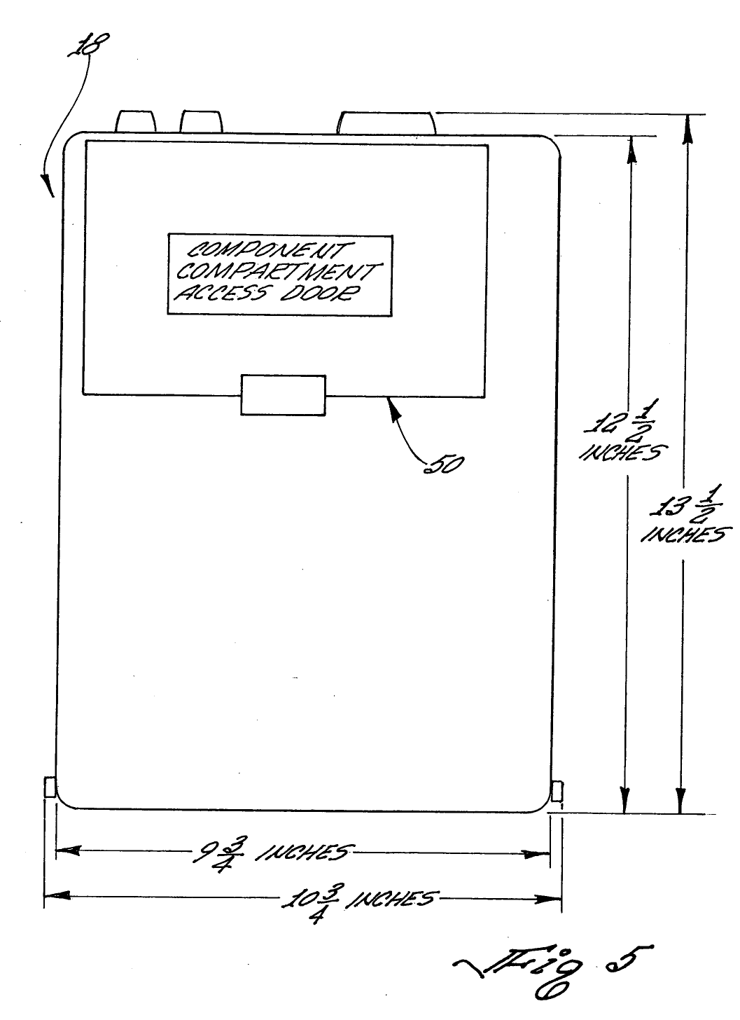

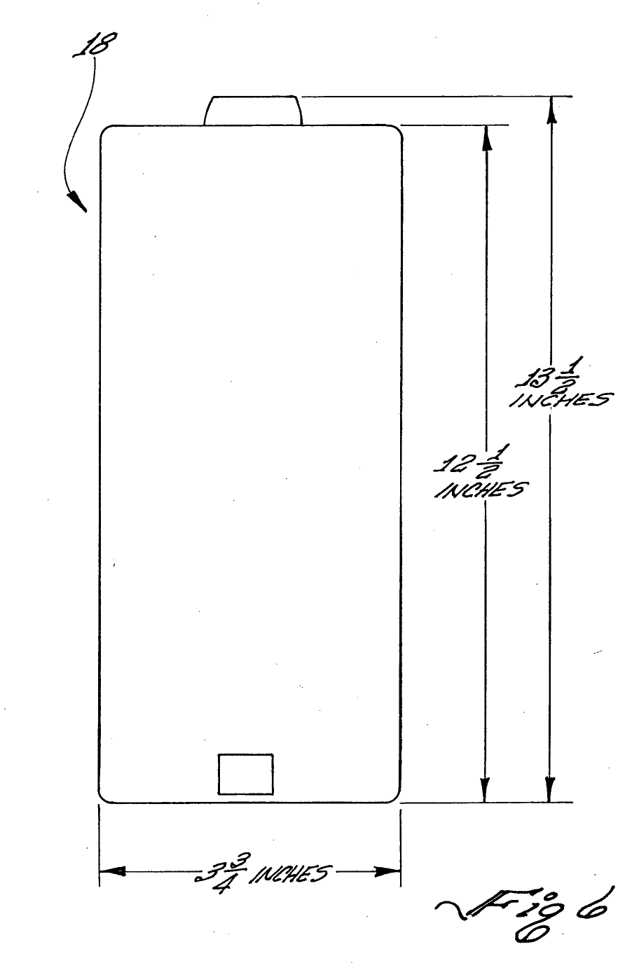

Referring to FIGS. 4-6, the connector panel 46 for recorder 18 is illustrated in FIG. 4. The connector panel 46 includes cable connectors J1, J2 and J3 which are used to connect signal lines/cables 24 and 26 to Digital VCR 18. The connector panel 46 also has a pair of mounting holes 48 which are used to install Digital VCR 18 on board an aircraft. As shown in FIG. 5, Digital VCR 18 has a component compartment access door 50. The overall dimensions of Digital VCR 18 are 10¾ inches by 13½ inches by 3¾ inches which makes the Sony DSR-50 easy to fit in an aircraft's cockpit as shown in FIGS. 4, 5 and 6. FIG. 5 shows a top view of the digital video cassette recorder 18 without a protective cover. FIG. 6 shows a side view of the digital video cassette recorder 18 without the protective cover.

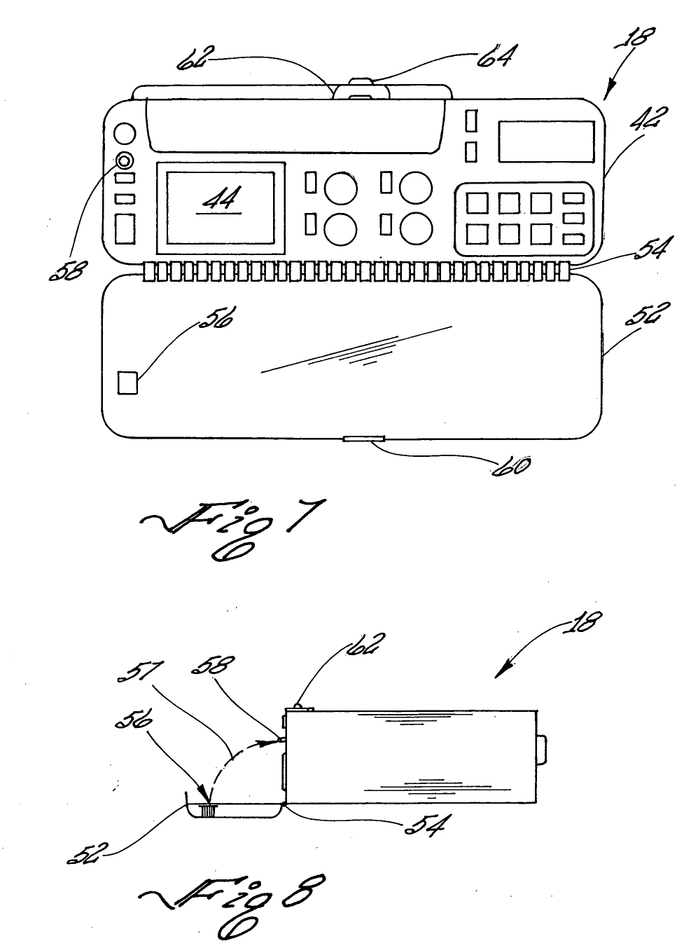

Referring to FIGS. 7 and 8, there is shown a protective face cover 52 which turns off the color Liquid Crystal Display 44 when the protective face cover 52 is closed. The protective face cover 52 is secured to the bottom edge of the control/front panel 42 of digital VCR recorder 18 by a piano style hinge 54. Hinge 54 allows a user to rotate protective face cover 52 in the manner indicated by arrow 57 to open and close protective face cover 52. Protective face cover 52 has a mash push button block 56 mounted on its inside surface which engages a mash button 58 on the control panel 42 of recorder 18. When cover 52 is closed and the mash button 42 is depressed, button 42 turns off the Liquid Crystal Display 44. A latch hasp 60 centrally located on the upper edge of protective face cover 52 engages a cover locking latch 62 mounted on the upper edge of front panel 42 to lock the protective face cover 52 closed and turn off Liquid Crystal Display 44. The cover locking latch 62 includes a release button 64 which a user depresses to open protective face cover 52 and view Liquid Crystal Display 44.

From the foregoing, it may readily be seen that the present invention comprises a new unique and exceedingly useful digital airborne video cassette recorder and player for recording aircraft video information which constitutes a considerable improvement over the known prior art. Obviously many modifications and variations of the present invention are possible in light of the above teachings. It is therefore to be understood that within the scope of the appended claims that the invention may be practiced otherwise than specifically described.

What is claimed is:

1. An airborne video cassette recording apparatus for use on an aircraft to record video data in a digital format generated by a video source located on board said aircraft, comprising:
(a) a video frame sync device connected to said video source to receive a video signal containing said video data from said video source, said video frame sync device stabilizing said video signal and adding a color burst to said video signal when said video signal from said video source consist of black and white video data;
(b) a GPS source for providing GPS information;
(c) a converter connected to said video frame sync to receive said video signal and said GPS source to receive said GPS information, said converter passing said video signal through said converter, said converter using said said video signal to encode time and date data and said GPS information onto a time code for each of a plurality of frames of said video data; and
(d) a video cassette recorder connected to said converter to receive said video signal and said time code for each of said plurality of frames of said video data, said video cassette recorder recording said video signal in said digital format on a cassette tape placed within said video cassette recorder and inserting said time code for each of said plurality of frames of said video data onto said cassette tape.

2. The video cassette recording apparatus of claim 1 further comprising a 28 volt to 12 volt step down power supply module connected to said video cassette recorder, said converter and said video frame sync device to supply electrical power to said video cassette recorder, said converter and said video frame sync device.

3. The video cassette recording apparatus of claim 1 wherein said video cassette recorder has a Liquid Crystal Display (LCD) for displaying said video data, said Liquid Crystal Display being located on a control panel for said video cassette recorder.

4. The video cassette recording apparatus of claim 3 further comprising an LCD protective cover positioned in front of the Liquid Crystal Display for said video cassette recorder, said LCD protective cover including:
(a) a piano style hinge positioned on the bottom edge of said LCD protective cover, said piano style hinge securing said LCD protective cover to the bottom edge of the control panel for said video cassette recorder wherein said piano style hinge allowing a user to rotate said LCD protective cover to open and close said LCD protective cover;
(b) a mash button located on the control panel of said video cassette recorder, said mash button being connected to said Liquid Crystal Display to turn off said Liquid Crystal Display when said mash button is depressed;
(c) a push button block mounted on an inner surface of said protective cover to engage and depress said mash button and turn off Liquid Crystal Display said when said protective cover is closed; and
(d) a latch hasp centrally located on an upper edge of said LCD protective cover, said latch hasp engaging a cover locking latch mounted on an upper edge of said control panel to lock the LCD protective cover closed and turn off said Liquid Crystal Display, said cover locking latch including release button which when depressed unlocks said LCD protective cover allowing said user to open said LCD protective cover and view said Liquid Crystal Display.

5. The video cassette recording apparatus of claim 1 wherein GPS information provided by said GPS source comprises Time, and Space, Position Information data.

6. The video cassette recording apparatus of claim 1 wherein said video cassette recorder records said video signal in an 8-bit digital component recording format which includes a 5:1 data compression ratio of said video data recorded on said cassette tape and a sampling rate of 4:1:1 for said video data recorded on said cassette tape.

7. The video cassette recording apparatus of claim 6 wherein said video cassette recorder reproduces said video data at a 6.3 MHz bandwidth which allows for a reproduction of said video data at 550 lines of horizontal resolution.

8. The video cassette recording apparatus of claim 1 wherein said video cassette recorder records said video data in a digital format which allows for recording of said video data for approximately 184 minutes recording time with a standard size cassette tape and approximately 40 minute recording time with a mini-size cassette tape.

9. An airborne video cassette recording apparatus for use on an aircraft to record video data in a digital format generated by a video source located on board said aircraft, comprising:
(a) a video frame sync device connected to said video source to receive a video signal containing said video data from said video source, said video frame sync device stabilizing said video signal and adding a color burst to said video signal when said video signal from said video source consist of black and white video data;
(b) a GPS source for providing GPS information wherein said GPS information includes Time, and Space, Position Information data;
(c) a GPS to SMPTE (Society of Motion Picture and Television Engineers) converter connected to said video frame sync to receive said video signal and said GPS source to receive said , said GPS to SMPTE converter passing said video signal through said GPS to SMPTE converter, said GPS to SMPTE converter using said video signal to encode time and date data and said GPS information onto a SMPTE time code for each of a plurality of frames of said video data;
(d) a video cassette recorder connected to said GPS to SMPTE converter to receive said video signal and said SMPTE time code for each of said plurality of frames of said video data, said video cassette recorder recording said video signal in an 8-bit digital component recording format on a cassette tape placed within said video cassette recorder and inserting said SMPTE time code for each of said plurality of frames of said video data onto said cassette tape, wherein said cassette tape provides for a recording time of approximately 184 minutes when said cassette tape is a standard size cassette tape; and
(e) a Liquid Crystal Display located on a control panel for said video cassette recorder, said Liquid Crystal Display displaying said video data and said SMPTE time code recorded on said cassette tape when said video cassette recorder is operating in a playback mode.

10. The video cassette recording apparatus of claim 1 further comprising a 28 volt to 12 volt step down power supply module connected to said video cassette recorder, said converter and said video frame sync device to supply electrical power to said video cassette recorder, said converter and said video frame sync device.

11. The video cassette recording apparatus of claim 9 wherein said video cassette recorder records said video signal in said 8-bit digital component recording format which includes a 5:1 data compression ratio of said video data recorded on said cassette tape and a sampling rate of 4:1:1 for said video data recorded on said cassette tape.

12. The video cassette recording apparatus of claim 11 wherein said video cassette recorder reproduces said video data at a 6.3 MHz bandwidth which allows for a reproduction of said video data at 550 lines of horizontal resolution.

13. The video cassette recording apparatus of claim 9 further comprising a two position switch module connected to said GPS to SMPTE converter, said two position switch module receiving said GPS information from an external GPS unit and an internal GPS receiver module wherein a user selects a first position for said modular switch to receive said GPS information from said external GPS unit and a second position for said switch module to receive said GPS information from said internal GPS receiver module.

14. The video cassette recording apparatus of claim 9 further comprising an LCD protective cover positioned in front of the Liquid Crystal Display for said video cassette recorder, said LCD protective cover including:
(a) a piano style hinge positioned on the bottom edge of said LCD protective cover, said piano style hinge securing said LCD protective cover to the bottom edge of the control panel for said video cassette recorder wherein said piano style hinge allowing a user to rotate said LCD protective cover to open and close said LCD protective cover;
(b) a mash button located on the control panel of said video cassette recorder, said mash button being connected to said Liquid Crystal Display to turn off said Liquid Crystal Display when said mash button is depressed;
(c) a push button block mounted on an inner surface of said protective cover to engage and depress said mash button and turn off Liquid Crystal Display said when said protective cover is closed; and
(d) a latch hasp centrally located on an upper edge of said LCD protective cover, said latch hasp engaging a cover locking latch mounted on an upper edge of said control panel to lock the LCD protective cover closed and turn off said Liquid Crystal Display, said cover locking latch including release button which when depressed unlocks said LCD protective cover allowing said user to open said LCD protective cover and view said Liquid Crystal Display.

15. A method for recording video data in a digital format generated by a video source located on board an aircraft, comprising the steps of:
(a) receiving GPS information from a GPS source wherein said GPS information includes Time, and Space, Position Information data;
(b) receiving a video signal containing said video data generated by a video source located on board said aircraft;
(c) adding a color burst to said video signal when said video signal from said video source consist of black and white video data;
(d) stabilizing said video signal wherein a video frame sync module stabilizes said video signal and adds said color burst to said video signal;
(e) transferring said video signal to a converter;
(e) encoding time and date data and said GPS information onto a time code for each of a plurality of frames of said video data, wherein said converter utilizes said video signal to encode said time and date data and GPS information onto said time code for each of said plurality of frames of said video data;
(f) passing said video signal through said converter to a video cassette recorder which contains a cassette tape
(g) transferring said time code for each of said plurality of frames of said video data to said video cassette recorder in a digital signal format; and
(h) recording said video signal including said time code for each of said plurality of frames of said video data on said cassette tape within said video recorder.

16. The method of claim 15 further comprising the step of displaying said video data including said time code, wherein a Liquid Crystal Display located on a control panel for said video cassette recorder displays said video data including said time code.

17. The method of claim 15 further comprising the step of providing a protective cover for said Liquid Crystal Display wherein said protective cover is positioned in front of said Liquid Crystal Display, said LCD protective cover including:
(a) a piano style hinge positioned on the bottom edge of said LCD protective cover, said piano style hinge securing said LCD protective cover to the bottom edge of the control panel for said video cassette recorder wherein said piano style hinge allowing a user to rotate said LCD protective cover to open and close said LCD protective cover;
(b) a mash button located on the control panel of said video cassette recorder, said mash button being connected to said Liquid Crystal Display to turn off said Liquid Crystal Display when said mash button is depressed;
(c) a push button block mounted on an inner surface of said protective cover to engage and depress said mash button and turn off Liquid Crystal Display said when said protective cover is closed; and
(d) a latch hasp centrally located on an upper edge of said LCD protective cover, said latch hasp engaging a cover locking latch mounted on an upper edge of said control panel to lock the LCD protective cover closed and turn off said Liquid Crystal Display, said cover locking latch including release button which when depressed unlocks said LCD protective cover allowing said user to open said LCD protective cover and view said Liquid Crystal Display.

18. The method of claim 15 wherein said time code for each of said plurality of frames of said video data comprises a SMPTE (Society of Motion Picture and Television Engineers) time code for each of said plurality of frame of said video data.

19. The method of claim 15 wherein said video cassette recorder records said video signal in an 8-bit digital component recording format which includes a 5:1 data compression ratio of said video data recorded on said cassette tape and a sampling rate of 4:1:1 for said video data recorded on said cassette tape.

20. The method of claim 15 wherein said video cassette recorder records said video data in a digital format which allows for recording of said video data for approximately 184 minutes recording time with a standard size cassette tape and approximately 40 minute recording time with a mini-size cassette tape.
